(19) United States
(12) Patent Application Publication
(10) Pub. No.: US 2010/0205552 A1
(43) Pub. Date: Aug. 12, 2010

(54) SYSTEM AND PROCESS TO CREATE WINDOW SHADES

(75) Inventors: Andrea Iten, Minneapolis, MN (US); Warren Beckwith Lee, JR., Brooklyn, NY (US)

Correspondence Address: SCHWEGMAN, LUNDBERG & WOESSNER, P.A., P.O. BOX 2938, MINNEAPOLIS, MN, 55402, US

(73) Assignee: Itenworks LLC, Minneapolis, MN (US)

(21) Appl. No.: 12/367,823

(22) Filed: Feb. 9, 2009

(51) Int. Cl. G06F 3/048; G06F 17/30

(52) U.S. Cl. 715/764; 707/E17.019

(57) ABSTRACT

A system includes a processor and a database coupled to the processor. The database includes one or more graphic designs. A user interface is coupled to the processor, and the user interface is configured to communicate with the processor and to allow a selection of a graphic design from the database and a selection of room criteria. The system further includes a printer. The processor is configured to display on the user interface a representation of a window shade in a room. The representation of the window shade includes the graphic design, and the room includes the room criteria. The processor is further configured to transmit the graphic design to the printer, and the printer is configured to print the graphic design on a window shade.

### TECHNICAL FIELD

The present disclosure relates to the design and production of window shades, and in an embodiment, but not by way of limitation, a system and method to create original and unique window shades.

### BACKGROUND

Window shades, of course, have been known for some time and serve very useful privacy and shading functions. However, even though window shades have been known for quite some time, the method of manufacturing window shades has not changed much over the years. Moreover, while window shades have been around for quite some time, window shades still predominantly come in standard neutral colors and tones, and any designs or decorations thereon are limited in nature. The art is therefore in need of a more flexible and variable system and process to manufacture window shades.

### BRIEF DESCRIPTION OF THE DRAWINGS

FIG. 1 is an example embodiment of a system that is configured to print graphic designs on window shades.

FIG. 2 is another example embodiment of a system that is configured to print graphic designs on window shades.

FIG. 3 is a flowchart of an example process to manufacture window shades with graphic designs thereon.

FIG. 4 is a block diagram of a computer system upon which one or more embodiments of the present disclosure can operate.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, and flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein.

A number of figures show block diagrams of systems and apparatuses of embodiments of the invention. A number of figures show flow diagrams illustrating systems and apparatuses for such embodiments. The operations of the flow diagrams will be described with references to the systems/apparatuses shown in the block diagrams. However, it should be understood that the operations of the flow diagrams could be performed by embodiments of systems and apparatuses other than those discussed with reference to the block diagrams, and embodiments discussed with reference to the systems/apparatuses could perform operations different than those discussed with reference to the flow diagrams.

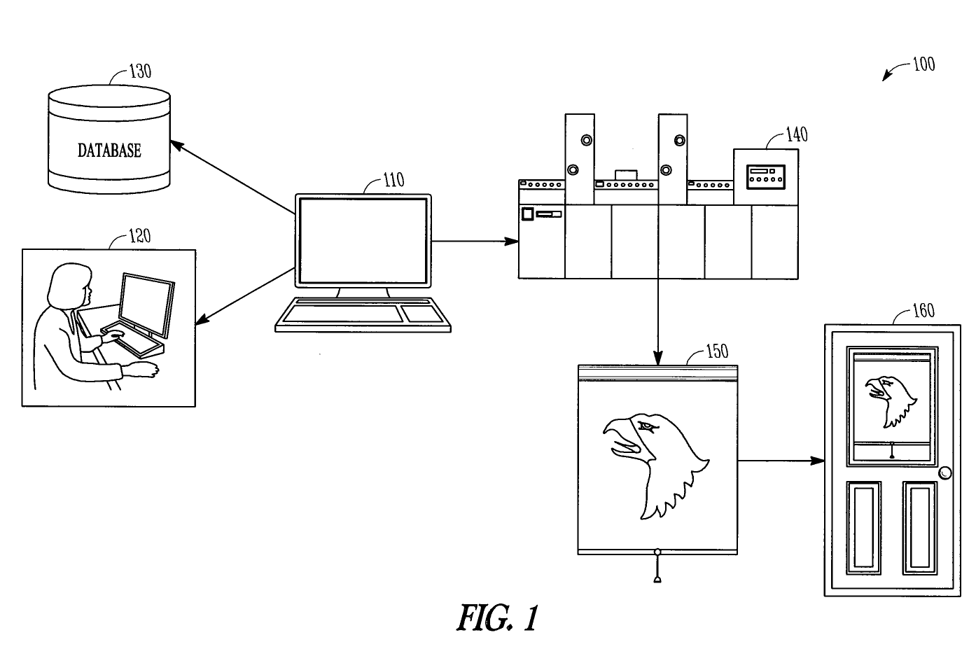

FIG. 1 is an example embodiment of a system 100 that is configured to print graphic designs on window shades. The system 100 includes a computer or other processor 110. The computer 110 is coupled to a user interface 120, a database 130, and a printer 140. In an embodiment, the printer 140 is a large scale industrial printer, capable of imprinting ink or other substance onto a material. The system 100 is configured such that a user, using the user interface 120, can access the database 130 of graphic designs or design templates, and transmit such designs to the printer 140 for imprinting on a window shade 150. The window shades 150 can later be installed on a door 160 or other residential and/or commercial structure. The designs can also be imprinted on window shade-like manufactures, such as screens or other artwork that can be displayed in a conference room, a lobby, or some other location. In an embodiment, the window shades are printed on a vinyl material. The window shades can also be printed onto a fabric such as linen, a shear weave, or other suitable material. In embodiments in which design templates are stored within the database 130, a user can use the design templates to create one or more unique and original designs, rather than select an existing design within the database 130.

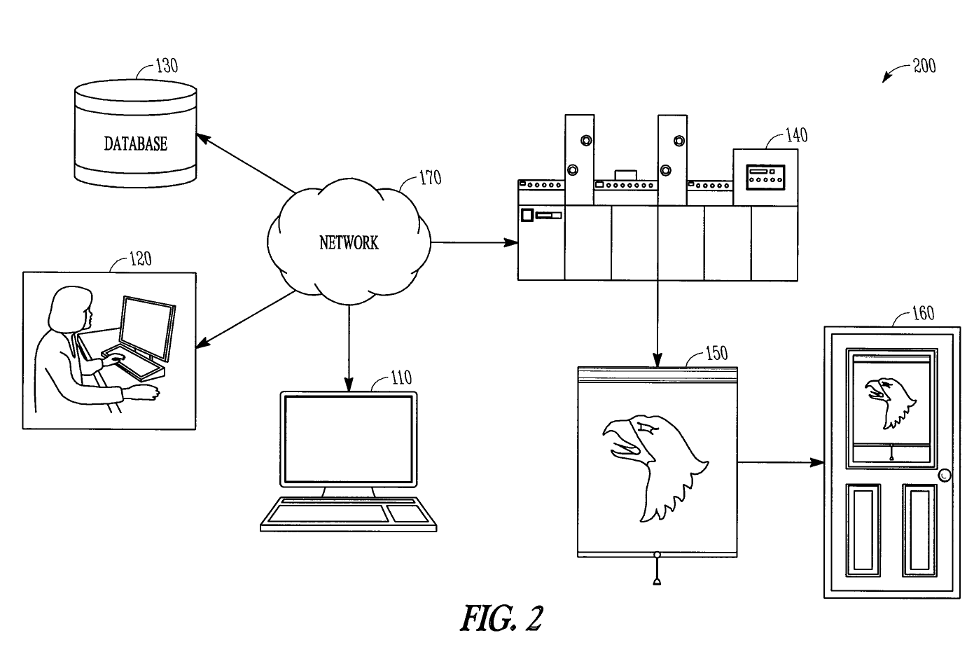

FIG. 2 is another example embodiment of a system 200 that is configured to print graphic designs on window shades. In the system 200, one or more of the computer 110, user interface 120, database 130, and printer 140 are coupled together using one or more networks 170.

The systems of FIGS. 1 and 2 can be physically arranged and installed in more than one configuration. For example, a system can be set up such that the user interface 120 is placed in a retail store, such as a home improvement store, and a customer can sit down at the terminal 120 and select and print out at the store the selected shades. In such a set up, the computer or processor 110 could be located at the store's headquarters, locally within the store, or at some other remote data center. In another configuration, a user can use his or her home computer to access, via the Internet, a company's database of window shade graphic designs and templates. In such an embodiment, the printing of the window shades could be done at a local store, and the user could then go to the store to retrieve the window shades. Alternatively, the printing of the shades could be done at the store's headquarters or elsewhere, and the window shades could be mailed or delivered to the customer.

The systems 100 and 200 can be configured to print the selected graphic designs on one side of a window shade or on both sides of a window shade. When printed on both sides of a window shade, the systems 100 and 200 can be configured such that the designs on both sides of the window shade are the same or are different.

The database 130 can be organized such that the graphic designs are categorized into one or more styles. Such categorized styles can include, for example, Americana, Cityscapes, Modern, Folk Bohemia, Teen Flair, Collegiate Spirit, and Great Outdoors. The database 130 can also store a variety of window shade hardware. The database 130 can further include data, and the processor 110 can include logic, to generate a virtual guided decoration tour of a home or other residence, thereby illustrating how each window shade design would look in such a home.

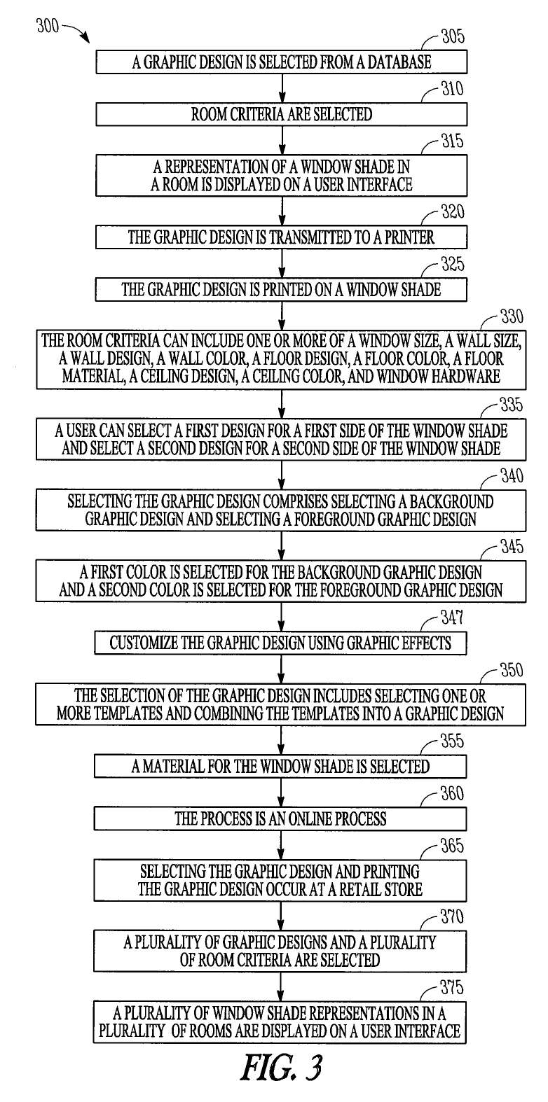

FIG. 3 is a flowchart of an example process 300 for manufacturing a unique and/or original window shade. FIG. 3 includes a number of process blocks 305 - 375. Though arranged serially in the example of FIG. 3, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

FIG. 3 illustrates that at 305 a graphic design is selected from a database. At 310, room criteria are selected. The room criteria can be selected from a database also, or the user can enter his or her own room criteria. At 315, a representation of a window shade in a room is displayed on a user interface. The representation of the window shade includes the graphic design, and the room includes the room criteria. At 320, the graphic design is transmitted to a printer, and at 325, the graphic design is printed on a window shade.

FIG. 3 further illustrates at 330 that the room criteria can include one or more of a window size, a wall size, a wall design, a wall color, a floor design, a floor color, a floor material, a ceiling design, a ceiling color, and window hardware. At 335, a user can select a first design for a first side of the window shade and select a second design for a second side of the window shade. At 340, selecting the graphic design comprises selecting a background graphic design and selecting a foreground graphic design, and at 345, a first color is selected for the background graphic design and a second color is selected for the foreground graphic design. At 347, the graphic design is customized using graphic effects. These graphic effects can include, but are not limited to, such things as blurring the graphic design, animating the graphic design (i.e., imbuing the graphic design with cartoon or cartoon-like features) posterizing the graphic design, or adding vintage features to the graphic design (e.g., to make the graphic design appear antique-like). At 350, the selection of the graphic design includes selecting one or more templates and combining the templates into a graphic design. At 355, a material for the window shade is selected. At 360, the process 300 is an online process. At 365, selecting the graphic design and printing the graphic design occur at a retail store. At 370, a plurality of graphic designs and a plurality of room criteria are selected, and at 375, a plurality of window shade representations in a plurality of rooms are displayed on a user interface. In this manner, a user can become his or her own interior designer, create a virtual tour of many rooms in a home or other dwelling involving many different window shades, and determine at the click of a button how a certain shade design looks in a certain room with certain wall, floor, ceiling, and window hardware adornment. The user interface can also display the outside of the building, so that a user can see how the window shade will look from that viewpoint.

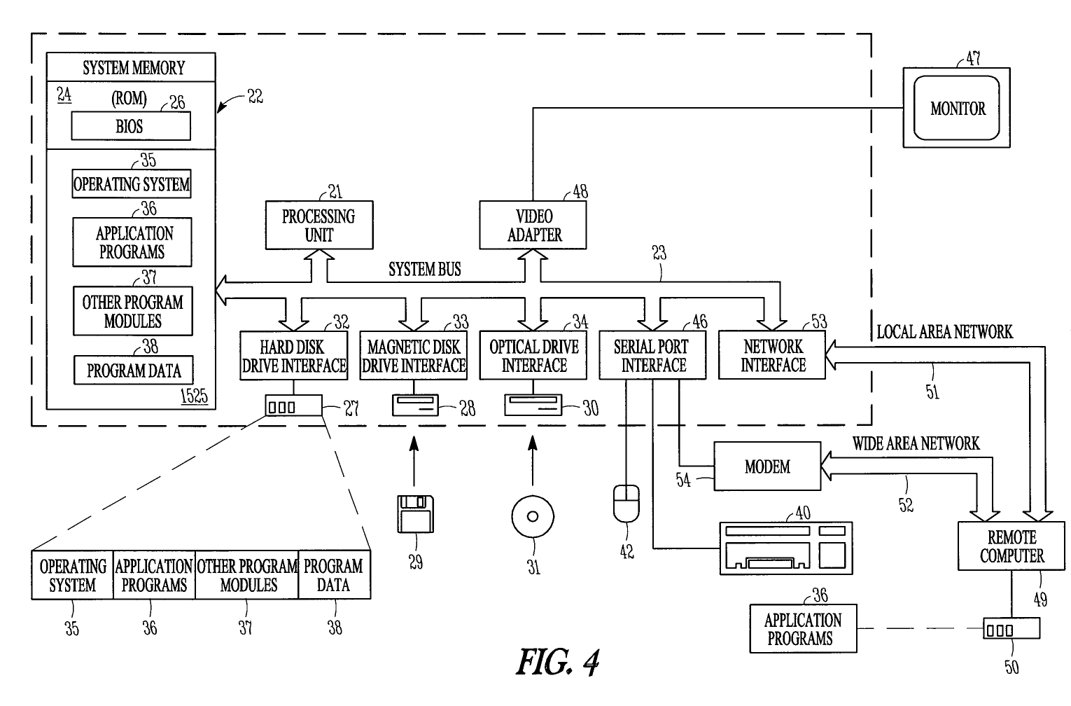

FIG. 4 is an overview diagram of a hardware and operating environment in conjunction with which embodiments of the invention may be practiced. The description of FIG. 4 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug-in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 4 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

1. A system comprising:
a processor;
a database coupled to the processor, the database comprising one or more graphic designs;
a user interface coupled to the processor, the user interface configured to communicate with the processor and to allow a selection of room criteria and to allow a selection of a graphic design from the database; and
a printer;
wherein the processor is configured to display on the user interface a representation of a window shade in a room, the representation of the window shade including the graphic design, and the room including the room criteria;
wherein the processor is configured to transmit the graphic design to the printer; and
wherein the printer is configured to print the graphic design on a window shade.

2. The system of claim 1, wherein the room criteria comprises one or more of a window size, a wall size, a wall color, a wall design, a floor design, a floor material, a floor color, a ceiling design, a ceiling color, and window hardware.

3. The system of claim 1, wherein the system is configured for placement in a retail store.

4. The system of claim 1, wherein the system is configured to print a first graphic design on a first side of the window shade and a second graphic design on a second side of the window shade.

5. The system of claim 1, wherein the graphic designs in the database are categorized according to one or more styles.

6. The system of claim 1, comprising a network interface coupling the processor to a computer network.

7. The system of claim 1, wherein the system is configured to receive from a user a digital photograph of a room, and further wherein the system is configured to display the digital photograph of the room and a representation of a window shade including the graphic design on the user interface.

8. The system of claim 1, comprising one or more design templates, the one or more design templates for constructing a graphic design.

9. The system of claim 1, wherein the system is configured to print the graphic design on a display screen.

10. A computerized process comprising:
selecting room criteria;
selecting a graphic design from a database;
displaying on a user interface a representation of a window shade in a room, the representation of the window shade including the graphic design, and the room including the room criteria;
transmitting the graphic design to a printer; and
printing the graphic design on a window shade.

11. The computerized process of claim 10, wherein the room criteria includes one or more of a window size, a wall size, a wall design, a wall color, a floor design, a floor color, a floor material, a ceiling design, a ceiling color, and window hardware.

12. The computerized process of claim 10, comprising selecting a first design for a first side of the window shade and selecting a second design for a second side of the window shade.

13. The computerized process of claim 10, wherein selecting the graphic design comprises selecting a background graphic design and selecting a foreground graphic design.

14. The computerized process of claim 13, comprising selecting a first color for the background graphic design and selecting a second color for the foreground graphic design.

15. The computerized process of claim 10, wherein selecting the graphic design comprises:
selecting one or more templates; and
combining the templates into a graphic design.

16. The computerized process of claim 10, comprising selecting a material for the window shade.

17. The computerized process of claim 10, wherein the computerized process comprises an online process.

18. The computerized process of claim 10, wherein the selecting a graphic design and the printing the graphic design occur at a retail store.

19. The computerized process of claim 10, comprising:
selecting a plurality of graphic designs and a plurality of room criteria; and
displaying on a user interface a plurality of window shade representations in a plurality of rooms.

20. A window shade, the window shade manufactured by:
selecting a graphic design from a database;
selecting room criteria;
displaying on a user interface a representation of a window shade in a room, the representation of the window shade including the graphic design, and the room including the room criteria;
transmitting the graphic design to a printer; and
printing the graphic design on a window shade.

21. The window shade of claim 20, wherein a first graphic design is printed on a first side of the window shade and a second graphic design is printed on a second side of the window shade.

22. The window shade of claim 20, wherein the window shade comprises a foreground graphic design and a background graphic design.

23. The window shade of claim 20, wherein the window shade comprises a fabric, a linen, a shear weave, or vinyl.

24. A computer-readable medium comprising instructions that when executed by a processor implement a process comprising:
selecting a graphic design from a database;
selecting room criteria;
displaying on a user interface a representation of a window shade in a room, the representation of the window shade including the graphic design, and the room including the room criteria;
transmitting the graphic design to a printer; and
printing the graphic design on a window shade.

25. The computer-readable medium of claim 24, wherein the room criteria includes one or more of a window size, a wall size, a wall design, a wall color, a floor design, a floor color, a floor material, a ceiling design, a ceiling color, and window hardware.

26. The computer-readable medium of claim 24, comprising instructions for selecting a first design for a first side of the window shade and selecting a second design for a second side of the window shade.

27. The computer-readable medium of claim 24, wherein selecting the graphic design comprises selecting a background graphic design and a foreground graphic design.

28. The computer-readable medium of claim 27, comprising selecting a first color for the background graphic design and selecting a second color for the foreground graphic design.

29. The computer-readable medium of claim 24, wherein selecting the graphic design comprises:
selecting one or more templates; and
combining the templates into a graphic design.

30. The computer-readable medium of claim 24, comprising instructions for selecting a material for the window shade.

31. The computer-readable medium of claim 24, comprising instructions for:
selecting a plurality of graphic designs and a plurality of room criteria; and
displaying on a user interface a plurality of window shade representations including the graphic designs in a plurality of rooms.

32. The system of claim 1, wherein the user interface is configured to customize the graphic design using graphic effects.

33. The system of claim 32, wherein the graphic effects include one or more of adding vintage features, blurring, animating, or posterizing.

34. The process of claim 10, comprising customizing the graphic design using graphic effects.

35. The process of claim 34, wherein the graphic effects in clued one or more of adding vintage features, blurring, animating, or posterizing.
